(19) United States
(12) Patent Application Publication
(10) Pub. No.: US 2025/0137638 A1
(43) Pub. Date: May 1, 2025

(54) WORK COIL FOR INDUCTION HEATED ABATEMENT APPARATUS

(71) Applicant: Edwards Limited, Burgess Hill, Sussex (GB)

(72) Inventors: Andrew James Seeley, Clevedon, Somerset (GB); Ian David Benzeval, Clevedon, Somerset (GB); Richard James Gumbleton, Clevedon, Somerset (GB); Aaron Bowen, Clevedon, Somerset (GB)

(21) Appl. No.: 18/996,556

(22) PCT Filed: Jul. 20, 2023
(86) PCT No.: PCT/GB2023/051913

§ 371 Date: Jan. 17, 2025

(30) Foreign Application Priority Data
Jul. 22, 2022 (GB) 2210729.6

(51) Int. Cl. F23G 7/06; H05B 6/10

(52) U.S. Cl. CPC F23G 7/063; H05B 6/108; F23G 2209/14

(57) ABSTRACT

An induction heated abatement apparatus includes a work coil configured to inductively heat a porous susceptor defining an abatement chamber for treating an effluent stream, wherein said work coil is hollow to define a conduit coupled with a source of reaction reagents and wherein at least one surface of said work coil defines a plurality of apertures in fluid communication with said conduit for conveying said reaction reagents from said conduit to said surface of said work coil for supply to said porous susceptor. The work coil is protected from the effects of overheating whilst also reducing wasted heat because the heat obtained by the reaction reagents used as coolant gas is recycled and is used to facilitate abatement in the porous susceptor defining an abatement chamber.

### CROSS-REFERENCE OF RELATED APPLICATION

This application is a Section 371 National Stage Application of International Application No. PCT/GB2023/051913, filed Jul. 20, 2023, and published as WO 2024/018215 A1 on Jan. 25, 2024, the content of which is hereby incorporated by reference in its entirety and which claims priority of British Application No. 2210729.6, filed Jul. 22, 2022.

### FIELD

The field of the invention relates to induction heated abatement apparatus and, in particular, a work coil for induction heated abatement apparatus.

### BACKGROUND

Induction heated abatement apparatus including work coils are known. Work coils are used for inductively heating a susceptor. In induction heated abatement apparatus, the susceptor may be a porous abatement chamber. Whilst induction heated abatement apparatus including work coils exist, they can have shortcomings. Accordingly, it is desired to provide an improved induction heated abatement apparatus and work coil.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided an induction heated abatement apparatus for treating an effluent stream from a semiconductor processing tool, comprising: a work coil configured to inductively heat a porous susceptor defining an abatement chamber for treating the effluent stream, wherein the work coil is hollow to define a conduit coupled with a source of reaction reagents and wherein at least one surface of the work coil defines a plurality of apertures in fluid communication with the conduit for conveying the reaction reagents from the conduit to the surface of the work coil for supply to the porous susceptor.

Some work coils, also known as inductors or inductor coils, for induction heated abatement apparatus are water cooled, but most work coils are not cooled. The first aspect recognises that there are shortcomings in efficiency of typical work coils. In particular, it has been realised that the absence of cooling can lead to undesirable surface oxidation of the work coil and annealing. As a result, work coils can become soft and easily deformed. Although water cooling can assist, this is inefficient as it causes heat losses.

Accordingly, an abatement apparatus is provided. The abatement apparatus may be an induction heated abatement apparatus. The abatement apparatus may be for treating an effluent stream from a semiconductor processing tool. The abatement apparatus may comprise a work coil. The work coil may be configured, adapted or arranged to inductively heat a porous susceptor. The porous susceptor may define an abatement chamber for treating the effluent stream. The work coil may be hollow to define a conduit. The conduit may be coupled with a source of reaction reagents. The conduit may have an inlet which receives the reaction reagents. At least one surface of the work coil may define a plurality of apertures or holes in fluid communication with the conduit for conveying or transferring the reaction reagents from the conduit to the surface of the work coil for supply to the porous susceptor. In this way, the work coil can be protected from the effects of overheating whilst also improving energy efficiency. This is because the reaction reagents used as a coolant are preheated and that heat can be recycled and used to facilitate abatement in the porous susceptor defining an abatement chamber, thereby improving energy efficiency. This arrangement could also obviate the need for a separate supply of reaction reagents to the abatement chamber as well as a separate cooling water supply.

The work coil may comprise a plurality of turns positioned along an axial length of the work coil and the apertures may be distributed circumferentially around each turn. In this way, the reaction reagent can be supplied to the porous susceptor defining an abatement chamber at desired locations and with desired flow rates to provide the required abatement conditions within the abatement chamber.

A distribution of the apertures may differ in different turns. Varying the position of the apertures allows customisation of the delivery of the reaction reagent by the work coil to the abatement chamber, as well as enabling the apertures to be located to avoid the different flow paths of current through the turns of the work coil.

The apertures in an axially outer turn may be distributed towards an axially central portion of that turn. In other words, the apertures in an axially outer or end turn may be distributed away from an axially outer or end portion of that turn. This arrangement locates the apertures away from the current which flows through an axially outermost portion of that turn and towards the axially central portion and/or an axially inner or end portion of that turn.

The apertures in an axially inner or medial turn may be distributed towards axially outer or end portions of that turn. In other words, the apertures in an axially inner or medial turn may distributed away from an axially central or middle portion of that turn. An axially inner turn is typically any turn that is not an ‘end’ turn of the coil. This arrangement locates the apertures away from the current which flows through an axial central portion of that turn and towards the axially outer portions of that turn.

A spacing between adjacent turns may differ along the axial length. By varying the spacing between turns, the generated magnetic field may be customised along the axial length of the abatement chamber. Also, the amounts of reaction reagent supplied to the porous susceptor can be customised.

The spacing may be reduced between axially outer adjacent turns compared with axially inner adjacent turns. In other words, the spacing may be increased between axially inner adjacent turns compared with axially outer adjacent turns. The generated magnetic field and therefore heating of the susceptor may be more even if the spacing between the axially end turns and their immediately adjacent turn is smaller than the spacing between adjacent inner turns (i.e., adjacent turns not including an end turn).

The plurality of apertures may be located on a surface facing towards the porous susceptor. This may help to direct reaction reagents towards locations of the susceptor experiencing higher levels of heating, thereby assisting with cooling of those locations.

The plurality of apertures may be located on a surface facing away from the porous susceptor. In this way, the path taken by the reactant reagent to the porous may be more tortuous. Consequently, a more even and diffuse supply of reactant reagent to the abatement chamber may be provided which can facilitate abatement.

The surface may be curved and/or planar. The work coil may have a cross section which is curved and/or a polygon. A section across the work coil may comprise any suitable cross-section which provides a conduit for the reaction reagents to pass therethrough, provide the required flow direction and ease of manufacture. The cross-section may comprise curved edges and/or straight edges. The shape of the cross section may be a trapezoid with curved edges. Such a shape is suitable for additive manufacturing.

The inlet may have a baffle configured, arranged or adapted to direct flow of the reaction reagents circumferentially within the work coil. Hence, the reaction reagents may flow around the turns of the work coil.

The baffle may be configured to split or divide flow of the reaction reagents in opposing circumferential directions within the work coil. The configuration of the baffle can help provide an even distribution of reaction reagent to the apertures (rather than having more reaction reagent passing through apertures near the inlet than those distant from the inlet).

The baffle may extend circumferentially along the conduit, terminating short of a blind end to divide the conduit into opposing circumferential flow portions. This extends the flow path by providing for counter-flows within each turn which helps to increase the heat-transfer between the work coil and the reaction reagents.

The work coil may comprise a helix and/or an axial stack of turns. Axial stacks, otherwise known as stacked strip coils, have been shown to have no appreciable detrimental effect to the electrical performance compared to helical coils yet they can provide significant manufacturing cost savings compared to a helical coil.

The work coil may comprise a plurality of the inlets located at different positions along the axial length of the work coil. In other words, the inlet may comprise inlets located at different positions along the axial length of the work coil. This can facilitate an even distribution of reaction reagent within the work coil and through the apertures.

The work coil may surround the porous susceptor. Typically, the work coil and porous susceptor are co-axially located.

The abatement apparatus may comprise at least one of the porous susceptor and a porous insulator configured to be positionable (or positioned) between the work coil and the porous susceptor. The reactant reagent can pass through the porous insulator, thereby allowing the work coil to supply reagent to the porous susceptor defining an abatement chamber. However, in use, radiated heat (for example, infrared) emitted by the porous susceptor defining an abatement chamber can be blocked to reduce heating the work coil and/or housing.

The abatement apparatus may comprise a housing configured to enclose the work coil. When the work coil is enclosed by the housing, the work coil may be positioned within a plenum of the housing.

According to a second aspect, there is provided a method of configuring an induction heated abatement apparatus for treating an effluent stream from a semiconductor processing tool, comprising: supplying a work coil configured to inductively heat a porous susceptor defining an abatement chamber for treating the effluent stream, wherein the work coil is hollow to define a conduit coupled with a source of reaction reagents and wherein at least one surface of the work coil defines a plurality of apertures in fluid communication with the conduit for conveying the reaction reagents from the conduit to the surface of the work coil for supply to the porous susceptor.

The method may comprise positioning the work coil about a porous susceptor defining an abatement chamber.

The method may comprise positioning a porous insulator between the work coil and the porous susceptor defining an abatement chamber.

The method may comprise positioning the work coil inside a housing.

The method may comprise connecting the inlet of the work coil to a supply of reactant reagent.

According to a third aspect, there is provided a method of operating an induction heated abatement apparatus for treating an effluent stream from a semiconductor processing tool, comprising: coupling the inlet of the work coil according to the first aspect to a reaction reagent supply; supplying reaction reagent to the conduit of the work coil via the inlet; evacuating the reaction reagent from the conduit of the work coil through the plurality of apertures.

The method of the second and third aspects may comprise steps corresponding to the optional features of the first aspect set out above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Preferred embodiments of the present invention will now be described further, with reference to the accompanying drawings, in which:

FIG. 1 shows a perspective view of a work coil of an induction heated abatement apparatus according to one embodiment;

FIG. 2 shows a front sectional view through a simplified induction heated abatement apparatus according to one embodiment;

FIG. 3 shows a plan view of a turn of a work coil according to one embodiment; and

FIG. 4 shows a schematic sectional view through a simplified work coil illustrating the preferred position of apertures in relation to current flow.

### DETAILED DESCRIPTION

Before discussing the embodiments in any more detail, first an overview will be provided. Some embodiments provide a work coil for an induction heated abatement apparatus for treating an effluent stream from a semiconductor processing tool. The work coil is configured to inductively heat a porous susceptor defining an abatement chamber for treating said effluent stream. The work coil is hollow to define a conduit, duct or tube allowing fluid to pass through the work coil. An inlet to the conduit of the work coil can be fluidly coupled with a source of reaction reagents. One or more surfaces of the work coil can define a plurality of apertures in fluid communication with the conduit which conveys reaction reagents within the conduit to the porous susceptor. The location, distribution and/or density of the apertures can be selected to avoid induced current paths within the work coil and/or to provide desired flow rates and flow directions. The work coil may be configured to supply reaction reagents in a diffuse manner to the susceptor. For example, the apertures may be evenly distributed about the circumference of turns of the work coil. Moreover, the apertures may be positioned to induce a tortuous path to the susceptor from the work coil, thereby diffusing the reaction reagents. The reaction reagents may act as a coolant for the work coil and act as a reaction reagent supply for the abatement chamber formed by the susceptor. In this way, heat absorbed by the reaction reagents from the work coil is recycled into heat used for abatement. The induction heated abatement apparatus may include the work coil, a porous abatement chamber susceptor and a porous insulator positioned between the work coil and the porous abatement chamber susceptor. A housing may be used to contain the work coil, the susceptor and the insulator.

### Work Coil

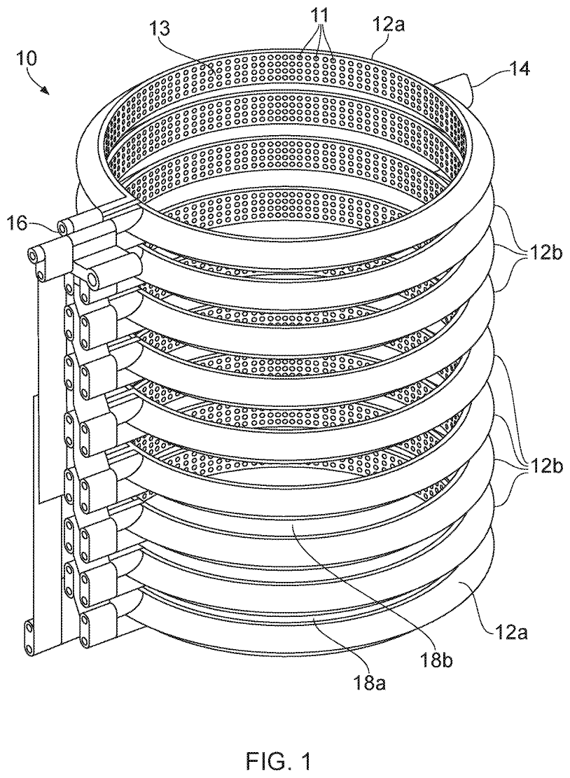

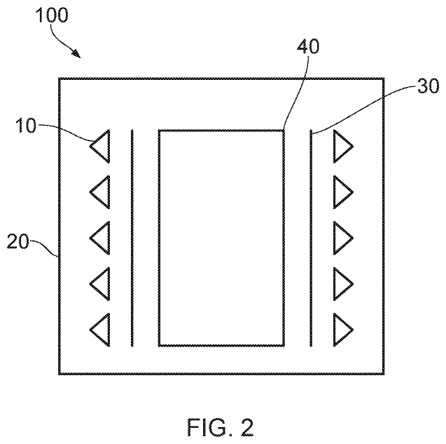

FIG. 1 shows an embodiment of a work coil 10 for use in an induction heated abatement apparatus, for example, the simplified abatement apparatus 100 shown in FIG. 2. The induction heated abatement apparatus 100 includes a housing 20, the work coil 10, a porous susceptor 40 sometimes referred to as an abatement chamber, and a porous insulator 30.

The work coil 10 comprises a stacked strip coil. That is to say that the work coil 10 is assembled from single loops stacked along a longitudinal axis. The coil 10 is hollow such that a conduit is defined within the coil. The cross-section of the work coil 10 is trapezoidal; however, any suitable cross-section may be used, such as for example, circular, square, with flat and/or curved faces. In some embodiments, the work coil comprises a helical coil alternatively or in addition to the stacked strip coil.

The work coil 10 includes a plurality of turns 12 arranged along a longitudinal axis defined by the work coil 10. The plurality of turns 12 comprise axially outer or end turns 12a and axially inner turns 12b. The turns 12 are coaxial with one another and adjacent turns 12 define a spacing therebetween 18. Adjacent axially outer turns 12a, i.e., the two turns closest to each end of the work coil 10, have a reduced space 18a with the adjacent axially inner turn 12b compared to space 18b between adjacent axially inner turns 12b.

Each turn 12 is coupled with an inlet 14 (only one shown in FIG. 1) configured to fluidly couple a reactant reagent source to the conduit defined by the hollow work coil 10. In embodiments, each turn of the stacked strip coil comprises an inlet.

The work coil 10 further comprises a plurality of holes or apertures 11 circumferentially spaced about an inside surface 13 of the turns 12 of the work coil 10. In this embodiment, the plurality of apertures 11 are arranged in rows of four, but other arrangements are possible. In other embodiments, the apertures 11 are arranged in one row or arranged in two or more rows. The plurality of apertures 11 fluidly couple the conduit of the work coil 10 to a plenum of the housing 20 of the abatement apparatus 100. Typically, the apertures 11 of the axially outer turns 12a are located away from an axially central portion of that turn so that there are no apertures on the axially central portion to avoid the induced electrical current flowing through these turns which is axially centred within the turns. The apertures of axially inner turns 12b are positioned within an axially central portion so that the axially outer portions of these turns do not have apertures positioned there to avoid the induced electrical current flowing through these turns which is located in the axially outer portions of the turns.

The surface defining the apertures 11 faces radially inward towards the insulator 30 and the susceptor 40. In some embodiments, the surface 13 defining the apertures faces radially outward, at an angle and/or radially outward at an angle and/or faces perpendicular to the circumference of the turns.

The work coil 10 further comprises an electrical connection 16 configured to electrically connect the work coil 10 to a suitable power source.

FIG. 2 illustrates schematically the induction heated abatement apparatus 100. The work coil 10 is positioned inside housing 20 and surrounds the porous susceptor 40. The porous insulator 30 is positioned coaxially with and between the work coil 10 and porous susceptor 40. The work coil 10, the susceptor 40 and the insulator 30 comprise a cylindrical cross-section. However, other shaped cross-sections may be used, for example, rectangular.

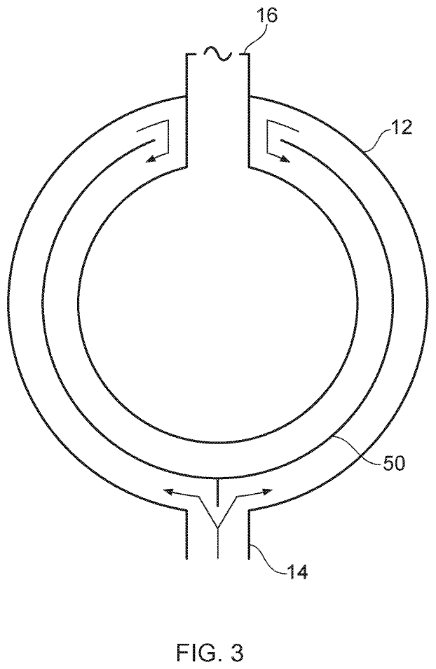

FIG. 3 shows a turn 12 of the work coil 10 having a baffle 50. The baffle 50 is positioned within the conduit defined by the hollow work coil 10 and comprises a T-shaped portion at the junction at the inlet 14 to direct a reactant reagent flow from the inlet 14 into opposing circumferential flows around a radially outer flow section. The ends of the baffle 50 stop short of a blind end of the turn 12 allowing the reactant reagent to flow to a radially inner flow section. In some embodiments, the baffle extends over 5% of the length between the inlet 14 towards the blind ends of the turn 12. In some embodiments, the baffle extends over 25%, over 50% or over 75% of the distance between the inlet 14 towards the blind ends of the turn 12. Positioning a baffle 50 to create the opposing circumferential flows helps provide an even distribution of reactant reagent to the circumferentially spaced apertures and extends the dwell time within the turn to improve heat transfer.

In use, the work coil 10 is positioned within the housing 20 of the abatement apparatus 100 and surrounds the porous insulator 30 and porous susceptor 40. An AC power supply supplies electrical energy to the work coil 10 to produce a varying magnetic field. The varying magnetic field induces eddy currents in the porous susceptor 40 causing it to heat up for abatement of an effluent stream. To facilitate abatement, reactant reagents are supplied to the abatement chamber defined by the porous susceptor. Whilst in operation, one or more reactant reagents (for example, compressed dried air (CDA)) can be supplied to the conduit of the work coil 10 via the inlet 14 to help prevent overheating of the work coil 10. Overheating may occur via radiant or other heat from the porous susceptor 40 or via resistive heating from self-induced eddy currents.

The reactant reagents supplied to the work coil 10 are guided by the baffle 50 around the turns 12 such that reagent-sparse areas in the work coil 10 are avoided. The reactant reagents are supplied to the plenum of the housing 20 from the work coil 10 through the apertures 11 defined in the surface(s) 13 of the turns 12 of the work coil 10. The reactant reagents may then pass through the porous insulator 30 and the porous susceptor 40 into the abatement chamber where they can facilitate abatement. The heat extracted by the reactant reagents from the work coil 10 can aid abatement and avoid the wasted heat associated with water cooled work coils.

It is preferable for the work coil 10 to evenly heat the porous susceptor 40. To this end, in some embodiments, the axially outer or end turns 12a of the work coil 10 are closer to its immediately adjacent inner turn 12b than the inner turns 12b are to each other. In other words, the spacing with the axially outer turns 12a is smaller than the spacing between adjacent axially inner turns 12b.

It is preferable for the work coil 10 to supply the reactant reagent to the abatement chamber in an evenly distributed and diffuse manner to facilitate abatement. To achieve this, in some embodiments, the apertures 11 of the work coil 10 are located on a face of the turns that is directed away from the porous susceptor 40. In this way, the reagents have a more tortuous path to the porous susceptor 40 which may provide a more diffuse supply.

The porous insulator 30 is configured to surround the porous susceptor 40 yet let reactant reagent gas through to the porous susceptor 40. The porous insulator 30 helps block radiant and other energy from the porous susceptor 40 from heating the work coil 10 and the housing 20 which could be dangerous and damage the abatement apparatus 100.

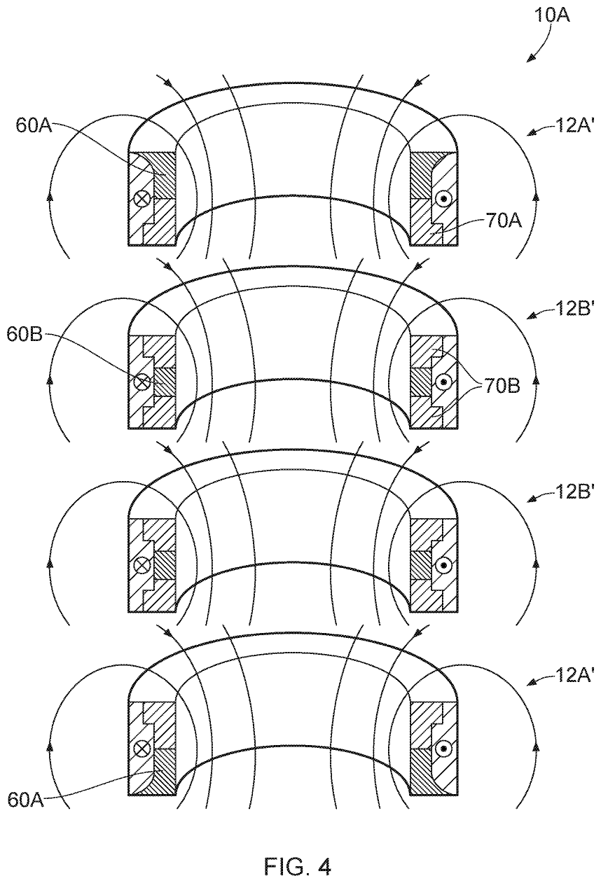

FIG. 4 illustrates schematically a simplified work coil 10a. As can be seen, regions 60a of high current distribution occur in the axially outermost portions of the axially outer turns 12a′. Hence, the apertures are located in an aperture region 70a away from this region 60a, towards the axially central and/or axially innermost portion of the axially outer turns 12a′. Regions 60b of high current distribution occur in the axially inner or central portions of the axially inner or central turns 12b′. Hence, the apertures are located in one or both aperture regions 70b away from this region 60b, towards the axially outermost portion of the axially inner turns 12a′.

In some embodiments, there is provided a work coil for an induction heated abatement apparatus as described below. Stacked strip coils have been built and tested and show no appreciable detriment in electrical performance compared to helical coils. The absence of cooling can lead to surface oxidation of the copper, also annealing. So coils become soft and easily deformed. Water cooled coils can also be produced in the stacked format. Water cooling protects the coil but is wasteful-heat is lost to the cooling water. Some embodiments air-cool the coils with the reagent air for the induction reactor or abatement chamber. The reagent air is split into as many streams as there are coils elements. The air enters each of the coil elements or turns and flows through a hollow portion of the coil element before discharging through a plurality of small holes in the vicinity of the susceptor. In one embodiment the holes are forward facing—i.e. they are in the face of the coil that induces the current in the susceptor. In this configuration, the air flows through the ceramic insulator directly under the shadow of the coil before entering the reaction chamber via the porous susceptor. The holes may be radial, they may be inclined. A combination of radial and inclined holes may be used. Holes may be of uniform size and/or distribution or there may be more “open area” towards the edges of the coil elements, less towards the centre. The air may flow out through rearward-projecting holes. These may be baffled to urge the air to turn forwards towards the susceptor. In this case the air does not flow in the shadow of the coil elements but rather flows in the interstitial gaps between the coil elements. This air may have taken a tortuous path through the coil element, passing first against the inner face of the coil before entering a portion of the coil element adapted for discharge of the air. The air flow to the individual coils may be identical or it may be controlled to give more air to some coils, less to others. Recognising that it is beneficial to have the coils closer together at either end, further apart at the middle, it may be preferred to supply more air to the centre coil elements, less to the end coil elements in proportion to their spacing. The coils may be formed of a copper alloy for example CuCrZr. The coils may be made by AM (additive manufacturing). The coils may be formed of an aluminium alloy. This may be copper plated. The plating may be applied via an electroless process. The work coil may be made at least partially from aluminium A20X.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. An induction heated abatement apparatus for treating an effluent stream from a semiconductor processing tool, comprising:
a work coil configured to inductively heat a porous susceptor defining an abatement chamber for treating said effluent stream, wherein said work coil is hollow to define a conduit coupled with a source of reaction reagents and wherein at least one surface of said work coil defines a plurality of apertures in fluid communication with said conduit for conveying said reaction reagents from said conduit to said surface of said work coil for supply to said porous susceptor.

2. The abatement apparatus of claim 1, wherein said work coil comprises a plurality of turns positioned along an axial length of said work coil and said apertures are distributed circumferentially around each turn.

3. The abatement apparatus of claim 2, wherein a distribution of said apertures differs in different turns.

4. The abatement apparatus of claim 2, wherein apertures in an axially outer turn are distributed towards an axially central portion of that turn.

5. The abatement apparatus of claim 2, wherein apertures in an axially outer turn are distributed away from an axially outer portion of that turn.

6. The abatement apparatus of claim 2, wherein apertures in an axially inner turn are distributed within axially outer portions of that turn.

7. The abatement apparatus of claim 2, wherein apertures in an axially inner turn are distributed away from an axially central portion of that turn.

8. The abatement apparatus of claim 2, wherein a spacing between adjacent turns differs along said axial length.

9. The abatement apparatus of claim 8, wherein said spacing is reduced between axially outer adjacent turns compared with axially inner adjacent turns.

10. The abatement apparatus of claim 8, wherein said spacing is increased between axially inner adjacent turns compared with axially outer adjacent turns.

11. The abatement apparatus of claim 1, wherein said plurality of apertures are located on a surface facing towards said porous susceptor.

12. The abatement apparatus of claim 2, wherein said plurality of apertures are located on a surface facing away from said porous susceptor.

13. The abatement apparatus of claim 11, wherein said surface is at least one of curved and planar.

14. The abatement apparatus of claim 1, wherein said work coil has a cross section which is at least one of curved and a polygon.

15. The abatement apparatus of claim 1, wherein said inlet has a baffle configured to direct flow of said reaction reagents circumferentially within said work coil.

16. The abatement apparatus of claim 15, wherein said baffle is configured to split flow of said reaction reagents in opposing circumferential directions within said work coil.

17. The abatement apparatus of claim 16, wherein said baffle extends circumferentially along said conduit, terminating short of a blind end to divide said conduit into opposing circumferential flow portions.

18. The abatement apparatus of claim 1, wherein said work coil comprises at least one of a helix and an axial stack of turns.

19. The abatement apparatus of claim 1, further comprising a plurality of said inlets located at different positions along said axial length of said work coil.

20. The abatement apparatus of claim 1, wherein said work coil surrounds said porous susceptor.

21. The abatement apparatus of claim 1, further comprising at least one of said porous susceptor and a porous insulator positioned between said work coil and said porous susceptor.

22. The abatement apparatus of claim 1, further comprising a housing configured to enclose said work coil.
